(19) United States
(12) Patent Application Publication
(10) Pub. No.: US 2025/0105462 A1
(43) Pub. Date: Mar. 27, 2025

(54) SEPARATOR AND LITHIUM SECONDARY BATTERY COMPRISING THE SAME

(71) Applicants: SK INNOVATION CO., LTD., Seoul (KR); SK IE TECHNOLOGY CO., LTD., Seoul (KR)

(72) Inventors: Tae Wook KWON, Daejeon (KR); Won Sub KWACK, Daejeon (KR); Kyu Young CHO, Daejeon (KR)

(21) Appl. No.: 18/777,233

(22) Filed: Jul. 18, 2024

(30) Foreign Application Priority Data
Jul. 20, 2023 (KR) 10-2023-0094461

(51) Int. Cl. H01M 50/491; H01M 10/052; H01M 50/42; H01M 50/423; H01M 50/443; H01M 50/446; H01M 50/449

(52) U.S. Cl. CPC H01M 50/491; H01M 10/052; H01M 50/42; H01M 50/423; H01M 50/443; H01M 50/446; H01M 50/449

(57) ABSTRACT

Separators and lithium secondary batteries including the separators that can exhibit excellent high-temperature storage stability and capacity retention rate of a lithium secondary battery, a low resistance increase rate, and significantly decreased gas emission are disclosed. In an example embodiment, a separator includes: a porous substrate and a coating layer formed on one or both surfaces of the porous substrate, wherein the coating layer includes a water-soluble composite binder including polyethyleneimine and a nitrogen-containing water-soluble polymer, and inorganic particles.

### CROSS-REFERENCE TO RELATED APPLICATION

This patent document claims the priority and benefits of Korean Patent Application No. 10-2023-0094461, filed on Jul. 20, 2023, the disclosure of which is hereby incorporated by reference in its entirety.

### TECHNICAL FIELD

The technology and implementations disclosed in this patent document generally relate to a separator and a lithium secondary battery comprising the separator.

### BACKGROUND

Recently, the capacity of lithium secondary batteries has been increased due to their applications in electric vehicles and energy storage devices. However, as the capacity of lithium secondary batteries increases, the risk of fire and explosion also grows, prompting various studies to improve their safety.

### SUMMARY

The disclosed technology can be implemented in some embodiments to provide a separator that may improve both high temperature storage characteristics and battery life.

The disclosed technology can be implemented in some embodiments to provide a separator that may significantly decrease gas emission and a lithium secondary battery using the separator.

The separator and the lithium secondary battery comprising the separator based on some embodiments of the disclosed technology may be widely applied to the green technology field such as electric vehicles, battery charging stations, and additionally, solar power generations and wind power generations using batteries. In addition, the separator and the lithium secondary battery comprising the separator based on some embodiments of the disclosed technology may be used in eco-friendly electric vehicles, hybrid vehicles, and others to prevent climate change by suppressing air pollution and greenhouse gas emission to prevent climate change.

In one general aspect, a separator comprises: a porous substrate and a coating layer on one or both surfaces of the porous substrate, wherein the coating layer comprises a water-soluble composite binder, and inorganic particles. In some implementations, the water-soluble composite binder comprises polyethyleneimine and a nitrogen-containing water-soluble polymer

In an example embodiment, the nitrogen-containing water-soluble polymer may comprise any one or two or more selected from the group consisting of polyvinylpyrrolidone, polyvinylpyrrolidone-based copolymers, and polyacrylamide-based resins.

In an example embodiment, the polyvinylpyrrolidone-based copolymer comprises a unit derived from N-vinyl-2-pyrrolidone and a unit derived from a comonomer, and the comonomer may be any one or a mixture of two or more selected from the group consisting of aromatic vinyl-based monomers; vinyl cyanide-based monomers; aromatic (meth)acrylate having an aryl group, an alkylaryl group, or an arylalkyl group having 6 to 20 carbon atoms; hydroxyl group-containing (meth)acrylate; epoxy group-containing (meth)acrylate; unsaturated carboxylic acid; vinyl acetate, and the like, but is not limited thereto.

In an example embodiment, the polyacrylamide-based resin may be a copolymer comprising a unit derived from a (meth)acrylamide-based monomer a unit derived from a comonomer.

In an example embodiment, the polyacrylamide-based resin may comprise (a) a structural unit derived from a (meth)acrylamide-based monomer, (b) a structural unit derived from a hydroxyl group-containing (meth)acryl-based monomer, and (c) a structural unit derived from a polyfunctional (meth)acrylamide-based monomer, but is not limited thereto.

In an example embodiment, the polyacrylamide-based resin may comprise (a) 65 to 96 mol % of the structural unit derived from a (meth)acrylamide-based monomer, (b) 3 to 34 mol % of the structural unit derived from a hydroxyl group-containing (meth)acryl-based monomer, and (c) 0.001 to 1 mol % of the structural unit derived from a polyfunctional (meth)acrylamide-based monomer, but is not limited thereto.

In an example embodiment, the polyacrylamide-based resin may have a weight average molecular weight of 100,000 to 2,000,000 g/mol, but is not limited thereto.

In an example embodiment, the inorganic particles may comprise one or more of boehmite and barium sulfate.

In an example embodiment, the inorganic particles may further comprise one or more types of inorganic particles selected from alumina, silica, aluminum hydroxide, magnesium hydroxide, calcium oxide, magnesium oxide, titanium oxide, aluminum nitrides, SrTiO3, SnO2, CeO2, NiO, ZnO, ZrO2, Y2O₃, SiC, and the like, in addition to any one selected from boehmite or barium sulfate or a mixture thereof, but are not limited thereto.

In an example embodiment, the inorganic particles may include a mixture of two or more types of inorganic particles having different average particle diameters from each other.

In an example embodiment, the inorganic particles may have an average particle diameter of 200 to 1000 nm, but are not limited thereto.

In an example embodiment, the coating layer may have a weight ratio between the inorganic particles and the water-soluble composite binder of 50:50 to 99.9:0.1, but is not limited thereto.

In an example embodiment, the content of the polyethyleneimine may be 1 to 50 wt % of the total content of the water-soluble composite binder, but is not limited thereto.

In an example embodiment, the polyethyleneimine and the nitrogen-containing water-soluble polymer may be in a weight ratio of 10 to 90:90 to 10, but is not limited thereto.

In an example embodiment, the water-soluble composite binder may further comprise one or more resins selected from the group consisting of polyvinyl acetate, acryl-based resins, polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polymethylmethacrylate, polyacrylonitrile, ethylene vinyl acetate copolymer, carboxymethyl cellulose, polyimide, and the like, but is not limited thereto.

In an example embodiment, the coating layer may have a thickness of 0.1 to 50% of the total thickness of the separator, but is not limited thereto.

In an example embodiment, the coating layer may be formed to be 0.5 to 10 g/m2, but is not limited thereto.

In an example embodiment, the porous substrate may be any one or a lamination of two or more selected from the group consisting of a porous film, a nonwoven fabric, and a woven fabric, but is not limited thereto.

In an example embodiment, the porous substrate may have a thickness of 1 to 80 μm, but is not limited thereto.

In another general aspect, a lithium secondary battery comprises the separator implemented based on an example embodiment.

Other features and aspects will be apparent from the following detailed description, the drawings, and the claims.

### DETAILED DESCRIPTION

Section headings are used in the present document only for ease of understanding and do not limit scope of the embodiments to the section in which they are described.

A lithium secondary battery may be manufactured by rolling or stacking cells composed of an anode, a cathode, and a separator placed between the anode and cathode into a cylindrical shape. This is then inserted into a pouch, and liquid electrolyte is injected. The electrolyte may facilitate charge transfer between electrodes and include a non-aqueous organic solvent and a salt.

When lithium secondary batteries that include a non-aqueous organic solvent and salt are stored at high temperatures for extended periods, they can ignite or explode due to various factors.

For example, in lithium secondary batteries that use carbonate-based organic solvents, a solid electrolyte interface (SEI) is formed on the surface of the anode as a result of electrolyte decomposition. The decomposition of carbonate organic solvents generates gas inside the battery. Additionally, the electrolyte can react sensitively with moisture, thereby producing gas inside the lithium secondary batteries. Depending on the type of non-aqueous organic solvent and anode active material, this gas can consist of hydrogen (H2), carbon monoxide (CO), carbon dioxide (CO2), methane (CH4), hydrogen fluoride (HF), and hydrogen sulfide (H2S).

Gas generation causes the battery to swell during charging, and if a fully charged lithium secondary battery is left at high temperatures, side reactions between the electrolyte and the anode surface can occur. This continuous gas generation increases the internal pressure of the lithium secondary battery, leading to volume expansion, reduced lifespan, and degraded performance.

The disclosed technology can be implemented in some embodiments to address these issues.

Hereinafter, some embodiments of the disclosed technology will be described in detail. However, the disclosed technology is not limited to the specific embodiments described in this patent document.

In some embodiments, the term “D50” may be used to indicate “average particle diameter.” For example, the term “D50” may be used to indicate a particle diameter of an inorganic particle corresponding to 50% in terms of a volume-based integrated fraction. For example, D50 is the diameter at which 50% of particles in a sample are larger and 50% are smaller. For example, an average particle diameter may be derived from particle size distribution results obtained by collecting a sample of particles which are a subject to be measured in accordance with the standard of KS A ISO 13320-1 and performing analysis using Multisizer 4e Coulter counter available from Beckman Coulter.

In some embodiments of the disclosed technology, a glass transition temperature (Tg) refers to a temperature range in which glass transition occurs. For example, the glass transition temperature (Tg) refers to a value measured using a dilatometer or a differential scanning calorimeter (DSC).

In some embodiments of the disclosed technology, weight average molecular weight (Mw), number average molecular weight (Mn), and viscosity average molecular weight (Mv) may be measured by any method, and may be, for example, a molecular weight in terms of polyethylene glycol analyzed with gel permeation chromatography (GPC). Specifically, Measurement the molecular weight was performed using GPC (EcoSEC HLC-8320 GPC Reflective Index detector from Tosoh Corporation), TSKgel guard PWx, two columns of TSKgel GMPWxl and TSKgel G2500PWxl (7.8×300 mm) was used as a GPC column, a 0.1 M aqueous NaNO₃ solution was used as a solvent, polyethylene glycol was used as a standard, and analysis was performed at 40° C. at a flow rate of 1 mL/min.

In some embodiments of the disclosed technology, the expression “as a main component” may be used to indicate that a specific component is used as a main component as compared with other components, for example, used at 50 wt % or more, more specifically 55 wt % or more, 60 wt % or more, 65 wt % or more, 70 wt % or more, 75 wt % or more, 80 wt % or more, 90 wt % or more, or 99 wt % or more.

In an example embodiment of the disclosed technology, a separator can exhibit excellent heat resistance, adhesive strength, and air permeability by forming a coating layer formed from a composition combined with a specific binder, and when the separator is used, a lithium secondary battery can exhibit improved high temperature storage characteristics and long-term life characteristics.

In addition, in an example embodiment of the disclosed technology, since a specific binder is combined and a coating layer is formed thereon using a composition combined with specific inorganic particles, a lithium secondary battery can significantly reduce gas emission. In some implementations, when the separator is applied to a lithium secondary battery using an electrolyte comprising LiPF6 as an electrolyte, gas emission may be significantly decreased, but the type of electrolyte is not limited thereto.

In an example embodiment of the disclosed technology, a separator comprises: a porous substrate and a coating layer formed on one or both surfaces of the porous substrate, wherein the coating layer comprises a water-soluble composite binder, and inorganic particles. In some implementations, the water-soluble composite binder may include polyethyleneimine and a nitrogen-containing water-soluble polymer.

In an embodiment, a separator comprises a porous substrate and a coating layer formed on one or both surfaces of the porous substrate, wherein the coating layer comprises a water-soluble composite binder, and boehmite particles. In some implementations, the water-soluble composite binder may include polyethyleneimine and a nitrogen-containing water-soluble polymer.

In an embodiment, a separator comprises a porous substrate and a coating layer formed on one or both surfaces of the porous substrate, wherein the coating layer comprises a water-soluble composite binder; and barium sulfate particles. In some implementations, the water-soluble composite binder may include polyethyleneimine and a nitrogen-containing water-soluble polymer.

In an embodiment, a separator comprises a porous substrate and a coating layer formed on one or both surfaces of the porous substrate, wherein the coating layer comprises a water-soluble composite binder; and boehmite particles and barium sulfate particles. In some implementations, the water-soluble composite binder may include polyethyleneimine and a nitrogen-containing water-soluble polymer.

In an embodiment, a separator comprises a porous substrate and a coating layer formed on one or both surfaces of the porous substrate, wherein the coating layer comprises a water-soluble composite binder; and any one selected from boehmite particles and barium sulfate particles or mixed particles thereof, and inorganic particles other than that. In some implementations, the water-soluble composite binder may include polyethyleneimine and a nitrogen-containing water-soluble polymer.

In an embodiment, a separator comprises a porous substrate and a coating layer formed on one or both surfaces of the porous substrate, wherein the coating layer comprises a water-soluble composite binder; and any one selected from boehmite particles and barium sulfate particles or mixed particles thereof, and the boehmite particles and the barium sulfate particles may be a mixture of two or more types of particles having different average particle diameters independently of each other. In some implementations, the water-soluble composite binder may include polyethyleneimine and a nitrogen-containing water-soluble polymer.

The embodiments discussed above are presented as examples and do not limit the disclosed technology. In addition, another layer may be further comprised between the porous substrate and the coating layer, and the type of layer which is further comprised is not particularly limited. In addition, the coating layer may be a lamination of two or more different types of coating layers, but is not limited thereto.

Hereinafter, each constituent element of the disclosed technology will be described in more detail.

### [Porous Substrate]

In an example embodiment, the porous substrate may include a commonly-used porous substrate, and may be a woven fabric, a non-woven fabric, a porous film, or a lamination of one or more selected therefrom, but is not limited thereto.

The material of the porous substrate is not limited. For example, polyolefins such as polyethylene and polypropylene, polyesters such as polyethylene terephthalate and polybutylene terephthalate, polyacetal, polyamide, polyimide, polycarbonate, polyether ether ketone, polyarylether ketone, polyetherimide, polyamideimide, polybenzimidazole, polyethersulfone, polyphenylene oxide, cyclic olefin copolymers, polyphenylene sulfide, polyethylene naphthalate, glass fiber, Teflon, polytetrafluoroethylene, and others may be used, and the material may be formed of one or more resins selected from the group consisting thereof.

As an example, the porous substrate may be a polyolefin-based porous substrate adjusted for micronization of pores, but is not limited thereto. The polyolefin-based porous substrate is usually manufactured in the form of a film and is not limited as long as it is usually used as a separator of a lithium secondary battery, and an example thereof comprises polyethylene, polypropylene, and copolymers thereof, but is not necessarily limited thereto.

The thickness of the porous substrate is not particularly limited, but may be 100 μm or less, 90 μm or less, 80 μm or less and 1 μm or more, 5 μm or more, or any value between the numerical values, and for example, 1 to 80 μm, 1 to 70 μm, 5 to 50 μm, or 5 to 30 μm, in terms of increasing the capacity of the lithium secondary battery at the same volume. The thickness of the porous substrate may be measured in the following: After stacking the porous substrate in 10 layers, measure the thickness with a Mitutoyo thickness gauge at 5 random points in the width direction, then derive the average thickness of the 10-layer porous substrate, and then divide by 10 to derive the overall average thickness of the single porous substrate.

### [Coating Layer]

The separator of the disclosed technology comprises a coating layer on one or both surfaces of the porous substrate.

In an example embodiment, the coating layer may be coated so that it corresponds to 50% or more, 60% or more, 70% or more, 80% or more, 90% or more, or 100% of the area of the porous substrate.

By way of example and not by limitation, the thickness of the coating layer may be in a range of 0.1 to 50%, 0.5 to 45%, or 1 to 40% of the total thickness of the separator. For example, when the coating layer is formed on one or both surfaces, each coating thickness may be 0.01 to μm, 0.1 to 10 μm, 0.3 to 8 μm, 0.3 to 5 μm, or 1 to 4 μm, but is not limited thereto. The thickness of the coating layer may be measured in the following: The thickness of the coating layer was derived by subtracting the average thickness of the single porous substrate from the average thickness of the single separator.

The weight per unit area of the coating layer may be 0.5 to 100 g/m2, 0.5 to 50 g/m2, 0.5 to 10 g/m2, 0.5 to 8 g/m2, or 0.5 to 5 g/m2, but is not necessarily limited thereto.

In an example embodiment, the coating layer may be formed from inorganic particles and a water-soluble composite binder, and as the inorganic particles are connected to each other, pores may be formed between the inorganic particles.

In some implementations, the coating layer may have the contents of the inorganic particles and the water-soluble composite binder at a weight ratio of 50:50 to 99.9:0.1, 80:20 to 99.9:0.1, 90:10 to 99.9:0.1, or 95:5 to 99:1. Within the range, a separator implemented based on some embodiments can exhibit smooth lithium ion movement and simultaneously expresses heat resistance and a low heat shrinkage rate, but is not limited thereto.

In an example embodiment, the content ratio of inorganic particles to binder may be a 80:20 ti 99.5:0.5, 85:15 to 99.5:0.5, 90:10 to 99.5:0.5, 90:10 to 99:1, 95:5 to 99:1, or about 97:3.

In an example embodiment, the coating layer may be formed by applying a slurry composition comprising the inorganic particles and the water-soluble composite binder. For example, the coating layer may comprise the inorganic particles, the water-soluble composite binder, and a solvent, and may have a solid content of 5 to 50 wt %, 5 to 45 wt %, or 5 to 40 wt %, but is not limited thereto.

In an example embodiment, the water-soluble composite binder may serve to bind the inorganic particles to each other and bind the inorganic particles to the porous substrate, and also, may serve to significantly decrease gas emission while also satisfying the high temperature storage characteristics and long-term life characteristics of the lithium secondary battery as intended in the disclosed technology.

In an example embodiment of the disclosed technology, since the water-soluble composite binder comprises both polyethyleneimine and a nitrogen-containing water-soluble polymer, the effect may be achieved. When only any one of them is comprised, it may be difficult to satisfy both the high temperature storage characteristics and the long-term life characteristics.

In addition, if necessary, a heat resistant binder or a water-dispersible binder which is commonly used in the art may be further comprised, and specifically, for example, the water-soluble composite binder comprises polyethyleneimine and the nitrogen-containing water-soluble polymer as main components. In some embodiments, the expression “comprised as a main component” means using a combined content of polyethyleneimine and the nitrogen-containing water-soluble polymer of 50 wt % or more, 60 wt % or more, 70 wt % or more, 80 wt % or more, 90 wt % or more, 100 wt %, or any range between the numerical values, with respect to the total content of the water-soluble composite binder. For example, the water-soluble composite binder may comprise 80 to 100 wt %, 85 to 100 wt %, 90 to 100 wt %, 95 to 100 wt %, or 98 to 100 wt % of polyethyleneimine and the nitrogen-containing water-soluble polymer.

The heat resistant binder or the water-dispersible binder may include a binder that is commonly used for binding the inorganic particles in the separator. For example, one or more resins selected from the group consisting of polyvinylpyrrolidone, polyvinyl acetate, acryl-based resins, polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polymethylmethacrylate, polyacrylonitrile, ethylene vinyl acetate copolymer, carboxymethyl cellulose, polyimide, and others may be comprised.

In an example embodiment, the polyethyleneimine may have a number average molecular weight (Mn) of, for example, 1,000 to 1,000,000 g/mol, 2,000 to 1,000,000 g/mol, 5,000 to 800,000 g/mol, 10,000 to 700,000 g/mol, 50,000 to 500,000 g/mol, or 100,000 to 500,000 g/mol, but is not limited thereto. Within the range, the intended effect may be appropriate to be achieved, but the disclosed technology is not limited thereto. The number average molecular weight may be measured by gel permeation chromatography (GPC), using polyethylene glycol as a standard material.

In some embodiments, the content of the polyethyleneimine is 50 wt % or less, for example, 1 to 50 wt %, 1 to 45 wt %, 1 to 40 wt %, or 1 to 35 wt % of the total content of the water-soluble composite binder for achieving the intended effect, but the disclosed technology is not limited thereto.

In an example embodiment, the polyethyleneimine and the nitrogen-containing water-soluble polymer may be used at a weight ratio of 10 to 90:90 to 10, 10 to 50:90 to 50, or 10 to 40:90 to 60, but the disclosed technology is not limited thereto.

In an example embodiment, the nitrogen-containing water-soluble polymer may comprise one or more selected from the group consisting of polyvinylpyrrolidone, polyvinylpyrrolidone-based copolymers, and polyacrylamide-based resins.

In some implementations, the polyvinylpyrrolidone may have a weight average molecular weight (Mw) of, for example, 10,000 to 1,000,000 g/mol, 20,000 to 900,000 g/mol, 30,000 to 700,000 g/mol, or 40,000 500,000 g/mol. Within the range, the intended effect may be favorably achieved, but the disclosed technology is not limited thereto.

The polyvinylpyrrolidone-based copolymer comprises a unit derived from N-vinyl-2-pyrrolidone and a unit derived from a comonomer, and the comonomer may be any one or a mixture of two or more selected from the group consisting of aromatic vinyl-based monomers; vinyl cyanide-based monomers; aromatic (meth)acrylate having an aryl group, an alkylaryl group, or an arylalkyl group having 6 to 20 carbon atoms; hydroxyl group-containing (meth)acrylate; epoxy group-containing (meth)acrylate; unsaturated carboxylic acid; and others, but is not limited thereto.

For example, the comonomer may be any one or a mixture of two or more selected from the group consisting of aromatic vinyl-based monomers comprising styrene, p-methylstyrene, m-methylstyrene, p-ethylstyrene, m-ethylstyrene, p-chlorostyrene, m-chlorostyrene, p-chloromethylstyrene, m-chloromethylstyrene, vinyl toluene, vinyl naphthalene, and the like; vinyl cyanide-based monomers comprising acrylonitrie, methacrylonitrile, and the like; aromatic (meth)acrylate having an aryl group, an alkylaryl group, or an arylalkyl group having 6 to 20 carbon atoms such as phenyl (meth)acrylate, benzyl (meth)acrylate, 2-phenylethyl (meth)acrylate, 3-phenylpropyl (meth)acrylate, 4-phenylbutyl (meth)acrylate, 2-2-methylphenylethyl (meth)acrylate, 2-3-methylphenylethyl (meth)acrylate, and 2-4-methylphenylethyl (meth)acrylate; hydroxyl group-containing (meth)acrylate such as 2-hydroxyethyl(meth)acrylate, 4-hydroxybutyl(meth)acrylate, 2-hydroxypropyl(meth)acrylate, 2-hydroxybutyl(meth)acrylate, 6-hydroxyhexyl(meth)acrylate, and 1,4-cyclohexanedimethanol mono(meth)acrylate; epoxy group-containing (meth)acrylate such as glycidyl acrylate and glycidyl methacrylate; unsaturated carboxylic acid such as acrylic acid and methacrylic acid; vinyl acetate; and the like, but is not limited thereto.

In addition, the polyvinylpyrrolidone-based copolymer may be a polyvinylpyrrolidone-polyvinyl acetate block copolymer, but is not limited thereto.

Without being limited, the polyvinylpyrrolidone-based copolymer may have a weight average molecular weight (Mw) of, for example, 10,000 to 1,000,000 g/mol, 50,000 to 900,000 g/mol, or 50,000 to 500,000 g/mol. Within the range, the intended effect may be favorably achieved, but the disclosed technology is not limited thereto.

In an example embodiment, the polyacrylamide-based resin may be a copolymer comprising a structural unit derived from a (meth)acrylamide-based monomer.

For example, the polyacrylamide-based resin may be a copolymer of a (meth)acrylamide-based monomer and a comonomer, and an example of the comonomer may be one or more selected from (meth)acrylic acid, a hydroxyl group-containing (meth)acryl-based monomer, a polyfunctional (meth)acrylamide-based monomer, and others, but is not limited thereto.

In an example embodiment, the polyacrylamide-based resin may comprise (a) a structural unit derived from a (meth)acrylamide-based monomer, (b) a structural unit derived from a hydroxyl group-containing (meth)acryl-based monomer, and (c) a structural unit derived from a polyfunctional (meth)acrylamide-based monomer. The (meth)acryl refers to acryl and/or methacryl.

The polyacrylamide-based resin uses the ternary copolymer rather than a homopolymer derived from an acrylamide-based monomer, thereby further decreasing high-temperature shrinkage and imparting high-temperature stability to provide a separator having better heat resistance, and also, providing a separator having better miscibility with polyethyleneimine, excellent adhesion to the porous substrate, and strengthened function of adsorbing carbon dioxide due to its use with the polyethyleneimine to have a better gas reduction effect. In addition, high-temperature storage stability and high-temperature capacity retention rate of the lithium secondary battery may be greatly improved.

In an example embodiment, the polyacrylamide-based resin may comprise (a) 65 to 96 mol % of the structural unit derived from a (meth)acrylamide-based monomer, (b) 3 to 34 mol % of the structural unit derived from a hydroxyl group-containing (meth)acryl-based monomer, and (c) 0.001 to 1 mol % of the structural unit derived from a polyfunctional (meth)acrylamide-based monomer.
(a) The (meth)acrylamide-based monomer polymerization unit of the polyacrylamide-based resin may be represented by the following Chemical Formula 1:

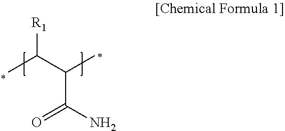

Here, R1 is hydrogen or a C1 to C6 alkyl group.
(b) The hydroxyl group-containing (meth)acryl-based monomer polymerization unit of the polyacrylamide-based resin may be represented by the following Chemical Formula 2:

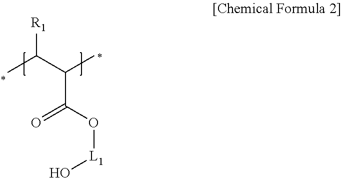

Here, R2 is hydrogen or a C1 to C6 alkyl group. In addition, L1 is a linear or branched C1 to C6 alkylene group.
(c) The polyfunctional (meth)acrylamide-based monomer polymerization unit may be produced by polymerizing a polyfunctional monomer represented by the following Chemical Formula 3:

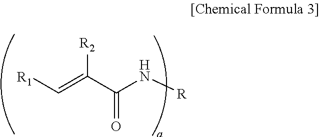

Here, R1 and R2 are independently hydrogen or a C1 to C6 alkyl group, R is a linear or branched C1 to C10 hydrocarbon group, and a is 2 to 6.

As an example, (a) the (meth)acrylamide-based monomer may be 65 to 96 mol %, 66 to 95 mol %, 67 to 94 mol %, 68 to 93 mol %, or 70.5 mol % to 91.5 mol %. (b) The hydroxyl group-containing (meth)acrylamide-based monomer may be 3 to 34 mol %, 4 to 33 mol %, 5 to 32 mol %, 6 to 31 mol %, or 8 to 29 mol %. (c) The polyfunctional (meth)acrylamide-based monomer may be comprised in the binder at 0.001 to 1 mol %, 0.005 to 0.9 mol %, or 0.01 to 0.5 mol %.

As an example, the polyacrylamide-based resin may be a crosslinked copolymer of acrylamide, hydroxyethyl acrylate, and N-methylenebisacrylamide, but is not limited thereto.

The polyacrylamide-based resin may have a weight average molecular weight of 100,000 g/mol or more, 150,000 g/mol or more, 200,000 g/mol or more, 250,000 g/mol or more and 2,000,000 g/mol or less, 1,500,000 g/mol or less, 1,000,000 g/mol or less, or any value between the numerical values. For example, the weight average molecular weight may be 100,000 to 2,000,000 g/mol, and within the range, adhesive strength to the porous substrate is better, a heat shrinkage rate may be further lowered, and high-temperature storage stability and capacity retention rate of the lithium secondary battery may be further improved, but the disclosed technology is not limited thereto. The weight average molecular weight is an average molecular weight in terms of polyethylene glycol as measured using gel permeation chromatography (GPC).

The viscosity of an aqueous solution of the polyacrylamide-based resin having a solid content of 10 wt % may be 3000 cps or less, 2500 cps or less, 2000 cps or less, or 1500 cps or less, but is not limited thereto. Within the range, when a slurry is prepared by mixing polyethyleneimine and inorganic particles, the viscosity of the slurry may be further lowered, and applicability may be further improved, which is thus preferred.

In an example embodiment, a solvent used in a slurry composition prepared for forming the coating layer may be, for example, water for preparing an aqueous solution, and, if necessary, may be used by further adding a solvent such as acetone, tetrahydrofuran, dimethylformamide, and N-methyl-2-pyrrolidone.

In an example embodiment, the inorganic particles are electrochemically stable, and any inorganic particles may be used without limitation as long as they are usually used for improving heat resistance and a heat shrinkage.

In an example embodiment, the inorganic particles may be any one or a mixture thereof selected from boehmite and barium sulfate, and may achieve excellent air permeability and gas reduction effect better when mixed with the water-soluble composite binder described above, by essentially comprising them. In addition, high-temperature storage stability and capacity retention rate of the lithium secondary battery may be achieved. In addition, if necessary, the inorganic particles comprise the boehmite, the barium sulfate, or the mixture thereof as a main component and may further comprise other inorganic particles. That is, the boehmite, the barium sulfate, or the mixture thereof may be used at 50 wt % or more, 60 wt % or more, 70 wt % or more, 80 wt % or more, 90 wt % or more, 95 wt % or more, 99 wt % or more and 100 wt % or less of the content of the inorganic particles, and may be used at any numerical value between the numerical values.

The inorganic particles, which may be further added, may be any inorganic particles commonly used in the art without limitation, and for example, may be one or more types of inorganic particles selected from alumina, silica, aluminum hydroxide, calcium oxide, magnesium hydroxide, magnesium oxide, titanium oxide, aluminum nitrides, SrTiO3, SnO2, CeO2, NiO, ZnO, ZrO2, Y2O₃, SiC, clay, and others.

By way of example and not by limitation, the size of the inorganic particles, specifically, an average particle diameter may be, for example, 50 nm or more, 100 nm or more, 200 nm or more, 300 nm or more and 1500 nm or less, 1000 nm or less, 800 nm or less, or in any range between the numerical values mentioned above, for smooth coating and excellent electrical properties. For example, it may be in a range of 100 to 1500 nm, 200 to 1000 nm, or 300 to 800 nm. The shape of the inorganic particles is not limited, and may be spherical, oval, needle-shaped, and others.

In an example embodiment, the inorganic particles used with the water-soluble composite binder may be boehmite, barium sulfate, or a mixture thereof, and the boehmite and the barium sulfate may be a mixture of two or more particles having different average particle diameters. That is, two or more particles having different average particle diameters may be mixed and used. For example, two or more boehmites having different average particle diameters, two or more barium sulfate having different average particle diameters, or boehmite and barium sulfate having different average particle diameters may be used.

For example, when two or more inorganic particles having different average particle diameters are used, first inorganic particles having a larger average particle diameter and second inorganic particles having a smaller average particle diameter may be mixed and used, and the average particle diameter of the first inorganic particles may be 200 to 500 nm, the average particle diameter of the second inorganic particles may be 500 to 1000 nm, and a difference in the average particle diameter between the first inorganic particles and the second inorganic particles may be 100 nm or more, for example, 100 to 500 nm. The first inorganic particles and the second inorganic particles may be independently boehmite and barium sulfate.

In an example embodiment, after the inorganic particles, the water-soluble composite binder, and the solvent are mixed to prepare a slurry composition, inorganic particles may be sufficiently crushed using a ball mill and the like to pulverize aggregates.

A method of coating the slurry composition on the porous substrate is not particularly limited, but the composition may be coated on one or both surfaces of the porous substrate by various methods such as roll coating, spin coating, dip coating, bar coating, die coating, slit coating, and ink-jet printing without limitation.

The separator according to an example embodiment of the disclosed technology may show an amount of change in air permeability (ΔG) as represented by the following Equation 1:

ΔG=G1−G2≤70 [Equation 1]

Here, G1 is a Gurley permeability of a separator comprising the coating layer, G2 is a Gurley permeability of the porous substrate itself, and the Gurley permeability is measured in accordance with ASTM D726 and has a unit of sec/100 cc.

In Equation 1, ΔG may be 70 sec/100 cc or less, 60 sec/100 cc or less, 50 sec/100 cc or less, 1 to 70 sec/100 ccc, or 1 to 60 sec/100 cc. Within the range, the change amount in air permeability is significantly small and the air permeability of the binder may be better.

The separator implemented based on an example embodiment of the disclosed technology may have a high-temperature shrinkage of 5% or less, 4% or less, 3% or less and 0.1% or more, 1% or more, or any value between the numerical values described above in both the machine direction and the transverse direction, as measured when the separator was allowed to stand in a hot air drying oven at 130° C. for 60 minutes. For example, the high-temperature shrinkage may be 1 to 5%. When the range is satisfied, a separator which has excellent heat resistance to have thermal stability may be provided. In addition, when the range is satisfied, the gas reduction effect and high-temperature stability of the lithium secondary battery may be excellent.

In addition, the separator implemented based on an example embodiment of the disclosed technology exhibits excellent adhesive strength between the inorganic particles and the porous substrate and may provide an effect of significantly small detachment of the inorganic particles.

### [Lithium Secondary Battery]

The lithium secondary battery based on an example embodiment of the disclosed technology may comprise the separator implemented based on an example embodiment described above between a positive electrode and a negative electrode. Herein, the positive electrode and the negative electrode may be used without limitation as long as they are commonly used in the lithium secondary battery.

In some implementations, the lithium secondary battery may comprise an electrolyte, for example, a liquid electrolyte, and the liquid electrolyte may comprise a dissociable lithium salt commonly used in the art and a nonaqueous solvent. In some implementations, the type of lithium salt is not limited. When the separator implemented based on some embodiments of the disclosed technology is applied, gas emission may be significantly decreased, particularly in an electrolyte comprising LiPF6. However, the disclosed technology is not limited thereto, and any commonly used electrolyte may be applied.

Hereinafter, examples of the disclosed technology will be further described with reference to the specific experimental examples. The experimental examples and the comparative examples only illustrate some embodiments of the disclosed technology, and various modifications and alterations of the examples may be made.

The physical properties were evaluated as follows.

### [Weight Average Molecular Weight]

Measurement was performed using GPC (EcoSEC HLC-8320 GPC Reflective Index detector from Tosoh Corporation), TSKgel guard PWx, two columns of TSKgel GMPWxl and TSKgel G2500PWxl (7.8×300 mm) was used as a GPC column, a 0.1 M aqueous NaNO3 solution was used as a solvent, polyethylene glycol was used as a standard, and analysis was performed at 40° C. at a flow rate of 1 mL/min.

### [Evaluation of Heat Shrinkage Rate]

A separator was cut into a square shape with a side of 10 cm and a transverse direction (TD) and a machine direction (MD) were indicated. A sample was placed in the center, 5 sheets of paper were placed on and under the sample, respectively, and the four sides of the paper were wrapped with tape. The sample wrapped in paper was allowed to stand in a hot air drying oven at 130° C. for 60 minutes. Thereafter, the sample was taken out, the separator was measured with a camera, and a shrinkage rate in the machine direction (MD) and a shrinkage rate in the transverse direction (TD) were calculated using the following equation:

$$High - temperature shrinkage rate in machine direction ( \% ) = ( length in machine direction before heating - length in machine direction after heating ) / length \text{} in machine direction before heating \times 100$$

$$High - temperature shrinkage rate in transverse direction ( \% ) = ( length in transverse direction before heating - length in transverse direction after heating ) / length \text{} in transverse direction before heating \times 100$$

### [Gurley Permeability]

As a gas permeability, a Gurley permeability was measured. It was measured according to the standard of ASTM D726, using Densometer available from Toyoseiki. A time it took for 100 cc of air to pass a separator having an area of 1 in2 was recorded in seconds and compared. The unit was sec/100 cc.

### [Adhesive Strength Test of Strawboard]

A separator was cut into a size of 50 mm×50 mm, and was placed on a rubber pad with an inorganic layer placed underneath. A black strawboard (20 mm×50 mm×T 0.25 mm) was placed between the separator and a rubber pad, and a constant pressure (10 g/cm2) was applied using a presser. The black strawboard was forcefully pulled aside, and a degree of an inorganic material adhered on the surface was confirmed and was identified as A/B/C depending on the adhered degree, considering the following grade:
A: no adhesion
B: inorganic material adhered in a small amount
C: binder and inorganic material adhered together

### [Thickness]

Separator: After stacking the separator in 10 layers, measure the thickness with a Mitutoyo thickness gauge at 5 random points in the width direction, then derive the average thickness of the 10-layer separator, and then divide by 10 to derive the overall average thickness of the single separator.

Porous substrate: After stacking the porous substrate in 10 layers, measure the thickness with a Mitutoyo thickness gauge at 5 random points in the width direction, then derive the average thickness of the 10-layer porous substrate, and then divide by 10 to derive the overall average thickness of the single porous substrate.

Coating layer: The thickness of the coating layer was derived by subtracting the average thickness of the single porous substrate from the average thickness of the single separator obtained in the manner described above.

### Example 1

### <Preparation of Slurry Composition>

97 wt % of boehmite (γ-AlO(OH)) having an average particle diameter of 600 nm, 2 wt % of a polyacrylamide-based resin (a crosslinked copolymer of acrylamide, hydroxyethylacrylate, and N-methylenebisacrylamide, indicated as “PAM1” in Table 1, average particle diameter: 270,000 g/mol), and 1 wt % of polyethyleneimine (PEI, available from NIPPON SHOKUBAI, EPOMIN™ P-3000, Mn=100,000 g/mol) were added to water as a solvent and stirring was performed to prepare a slurry composition having a solid content concentration of 30 wt %.

### <Manufacture of Separator>

A separator substrate (ENPASS, SK IE technology Co., Ltd.) having a width of 150 mm, a length of 1000 M, and a thickness of 9 μm was used. The slurry composition prepared above was bar-coated on both surface of the substrate at a speed of 3 m/min to form a coating layer.

Thereafter, the substrate was dried by passing through a hot air drier at 40° C. wound in a roll shape. The thickness of the coated separator measured after the winding was a total of 13 m and the thickness of the coating layer was 2 μm per one surface.

The physical properties of the manufactured separator were evaluated, and are shown in the following Table 1.

### <Manufacture of Lithium Secondary Battery>

95 wt % of artificial graphite as a negative electrode active material, 3 wt % of acrylic latex having Tg of −52° C. (solid content of 20 wt %) as a fusing agent, and 2 wt % of carboxymethyl cellulose (CMC) as a thickener were added to water and stirring was performed to prepare a uniform negative electrode slurry. The slurry was coated on an copper foil having a thickness of m, dried, and pressed to manufacture a negative electrode plate having a thickness of 150 m.

94 wt % of LiCoO2 as a positive electrode active material, 2.5 wt % of polyvinylidene fluoride as a fusing agent, and 3.5 wt % of carbon black as a conductive agent were added to N-methyl-2-pyrrolidone (NMP) as a solvent and stirring was performed to prepare a uniform positive electrode slurry. The slurry was coated on an aluminum foil having a thickness of 30 μm, dried, and pressed to manufacture a positive electrode plate having a thickness of 150 m.

A separator was disposed between the positive electrode and the negative electrode to manufacture a battery in a pouch form. An electrolyte solution to which ethylene carbonate (Ec)/ethylmethyl carbonate (EMC)/dimethyl carbonate (DMC)=25:45:20 (volume ratio) in which 1 M lithium hexafluorophosphate (LiPF6) was dissolved was added, was injected into the assembled battery. In order to seal the opening aluminum packaging, the opening of aluminum exterior was closed by heat sealing at 165° C., thereby manufacturing a pouch-type lithium secondary battery of 2 Ah. The physical properties of the manufactured batteries were evaluated, and are shown in Table 2.

### Example 2

A slurry composition was prepared in the same manner as in Example 1, except that barium sulfate having an average particle diameter of 500 nm was used instead of boehmite as inorganic particles.

That is, 97 wt % of barium sulfate having an average particle diameter of 500 nm, 2 wt % of the polyacrylamide-based resin (indicated as “PAM1” in Table 1), and 1 wt % of polyethyleneimine (PEI, available from NIPPON SHOKUBAI, EPOMIN™ P-3000) were added to water as a solvent and stirring was performed to prepare a slurry composition having a solid content concentration of 30 wt %.

The physical properties of the manufactured separator and battery were evaluated and are shown in Tables 1 and 2.

### Example 3

A slurry composition was prepared in the same manner as in Example 1, except that boehmite and barium sulfate were mixed and used as inorganic particles.

That is, 50 wt % of boehmite (γ-AlO(OH)) having an average particle diameter of 600 nm, 47 wt % of barium sulfate having an average particle diameter of 500 nm, 2 wt % of the polyacrylamide-based resin (indicated as “PAM1” in Table 1), and 1 wt % of polyethyleneimine (PEI, available from NIPPON SHOKUBAI, EPOMIN™ P-3000) were added to water as a solvent and stirring was performed to prepare a slurry composition having a solid content concentration of 30 wt %.

The physical properties of the manufactured separator and battery were evaluated and are shown in Tables 1 and 2.

### Example 4

A slurry composition was prepared in the same manner as in Example 1, except that two types of boehmites having different average particle diameters were used.

That is, 77 wt % of boehmite (γ-AlO(OH)) having an average particle diameter of 600 nm, 20 wt % of boehmite having an average particle diameter of 300 nm, 2 wt % of the polyacrylamide-based resin (indicated as “PAM1” in Table 1), and 1 wt % of polyethyleneimine (PEI, available from NIPPON SHOKUBAI, EPOMIN™ P-3000) were added to water as a solvent and stirring was performed to prepare a slurry composition having a solid content concentration of 30 wt %.

The physical properties of the manufactured separator and battery were evaluated and are shown in Tables 1 and 2.

### Example 5

A slurry composition was prepared in the same manner as in Example 1, except that two types of barium sulfates having different average particle diameters were used.

That is, 50 wt % of barium sulfate having an average particle diameter of 800 nm, 47 wt % of barium sulfate having an average particle diameter of 500 nm, 2 wt % of the polyacrylamide-based resin (indicated as “PAM1” in Table 1), and 1 wt % of polyethyleneimine (PEI, available from NIPPON SHOKUBAI, EPOMIN™ P-3000) were added to water as a solvent and stirring was performed to prepare a slurry composition having a solid content concentration of 30 wt %.

The physical properties of the manufactured separator and battery were evaluated and are shown in Tables 1 and 2.

### Example 6

A slurry composition was prepared in the same manner as in Example 1, except that a polyacrylamide-based resin (indicated as “PAM2” in the table, a copolymer of acrylic acid and acrylamide, weight average molecular weight: 100,000 g/mol) was used instead of the polyacrylamide-based resin (PAM1).

The physical properties of the manufactured separator and battery were evaluated and are shown in Tables 1 and 2.

### Example 7

A slurry composition was prepared in the same manner as in Example 1, except that polyvinylpyrrolidone (PVP, available from Sigma-Aldrich, CAS Number: 9003-39-8) was used instead of a polyacrylamide-based resin (PAM1).

The physical properties of the manufactured separator and battery were evaluated and are shown in Tables 1 and 2.

### Example 8

A slurry composition was prepared in the same manner as in Example 2, except that polyvinylpyrrolidone (PVP, available from Sigma-Aldrich, CAS Number: 9003-39-8) was used instead of a polyacrylamide-based resin (PAM1).

The physical properties of the manufactured separator and battery were evaluated and are shown in Tables 1 and 2.

### Example 9

A slurry composition was prepared in the same manner as in Example 3, except that polyvinylpyrrolidone (PVP, available from Sigma-Aldrich, CAS Number: 9003-39-8) was used instead of a polyacrylamide-based resin (PAM1).

The physical properties of the manufactured separator and battery were evaluated and are shown in Tables 1 and 2.

### Example 10

A slurry composition was prepared in the same manner as in Example 4, except that polyvinylpyrrolidone (PVP, available from Sigma-Aldrich, CAS Number: 9003-39-8) was used instead of a polyacrylamide-based resin (PAM1).

The physical properties of the manufactured separator and battery were evaluated and are shown in Tables 1 and 2.

### Example 11

A slurry composition was prepared in the same manner as in Example 5, except that polyvinylpyrrolidone (PVP, available from Sigma-Aldrich, CAS Number: 9003-39-8) was used instead of a polyacrylamide-based resin (PAM1).

The physical properties of the manufactured separator and battery were evaluated and are shown in Tables 1 and 2.

### Comparative Example 1

A slurry composition was prepared in the same manner as in Example 1, except that a water dispersible acryl-based binder (comprising 2 wt % of polyvinyl alcohol having a melting temperature of 220° C. and a saponification degree of 99%, Tg: −52° C.) having a latex content of 20 wt % was used alone as a binder.

That is, 97 wt % of boehmite (γ-AlO(OH)) having an average particle diameter of 600 nm and 3 wt % of acryl-based binder were added to water as a solvent and stirring was performed to prepare a slurry composition having a solid content concentration of 30 wt %.

The physical properties of the manufactured separator and battery were evaluated and are shown in Tables 1 and 2.

### Comparative Example 2

A slurry composition was prepared in the same manner as in Example 1, except that the polyacrylamide-based resin “PAM1” was used alone as a binder.

That is, 97 wt % of boehmite (γ-AlO(OH)) having an average particle diameter of 600 nm and 3 wt % of the polyacrylamide-based resin “PAM1” were added to water as a solvent and stirred to prepare a slurry composition having a solid content concentration of 30 wt %.

The physical properties of the manufactured separator and battery were evaluated and are shown in Tables 1 and 2.

### Comparative Example 3

A slurry composition was prepared in the same manner as in Example 1, except that polyethyleneimine (PEI, available from NIPPON SHOKUBAI, EPOMIN™ P-3000) was used alone as a binder.

That is, 97 wt % of boehmite (γ-AlO(OH), available from Nabaltec, Apyrl OH60) having an average particle diameter of 700 nm and 3 wt % of polyethyleneimine (PEI, available from NIPPON SHOKUBAI, EPOMIN™ P-3000) were added to water as a solvent and stirring was performed to prepare a slurry composition having a solid content concentration of 30 wt %.

The physical properties of the manufactured separator and battery were evaluated and are shown in Tables 1 and 2.

### Comparative Example 4

A slurry composition was prepared in the same manner as in Example 1, except that a polyacrylamide-based resin (indicated as “PAM2” in the table, a copolymer of acrylic acid and acrylamide) was used alone as a binder.

That is, 97 wt % of boehmite (γ-AlO(OH)) having an average particle diameter of 600 nm and 3 wt % of the polyacrylamide-based resin (indicated as “PAM2” in the table, a copolymer of acrylic acid and acrylamide) were added to water as a solvent and stirred to prepare a slurry composition having a solid content concentration of 30 wt %.

The physical properties of the manufactured separator and battery were evaluated and are shown in Tables 1 and 2.

TABLE 1

| | Type of inorganic | | Coating | Coating | Gurley | Heat shrinkage | Adhesive |
|---|---|---|---|---|---|---|---|
| | particles/average | | thickness | amount | permeability | rate at 130° C. | strength to |
| | particle diameter | Binder | (μm) | (g/m²) | (sec/100 cc) | (%) MD/TD | strawboard |
| Ex. 1 | Boehmite 600 nm | PAM1 + PEI | 4 | 4.4 | 95 | 2.0/1.6 | A |
| Ex. 2 | Barium sulfate 500 nm | PAM1 + PEI | 4 | 5.9 | 98 | 3.6/3.3 | A |
| Ex. 3 | Boehmite 600 nm + | PAM1 + PEI | 4 | 5.3 | 103 | 2.2/1.5 | A |
| | Barium sulfate 500 nm | | | | | | |
| Ex. 4 | Boehmite 600 nm + | PAM1 + PEI | 4 | 4.5 | 107 | 1.5/0.5 | A |
| | 300 nm | | | | | | |
| Ex. 5 | Barium sulfate 800 nm + | PAM1 + PEI | 4 | 6.1 | 112 | 2.0/2.0 | A |
| | barium sulfate 500 nm | | | | | | |
| Ex. 6 | Boehmite 600 nm | PAM2 + PEI | 4 | 4.3 | 95 | 3.0/2.5 | A |
| Ex. 7 | Boehmite 600 nm | PVP + PEI | 4 | 4.3 | 95 | 4.0/3.6 | A |
| Ex. 8 | Barium sulfate 500 nm | PVP + PEI | 4 | 5.8 | 98 | 3.6/3.3 | A |
| Ex. 9 | Boehmite 600 nm + | PVP + PEI | 4 | 5.1 | 101 | 4.2/3.7 | A |
| | Barium sulfate 500 nm | | | | | | |
| Ex. 10 | Boehmite 600 nm + | PVP + PEI | 4 | 4.4 | 105 | 4.0/3.0 | A |
| | 300 nm | | | | | | |
| Ex. 11 | Barium sulfate 800 nm + | PVP + PEI | 4 | 6.3 | 115 | 3.5/3.0 | A |
| | barium sulfate 500 nm | | | | | | |
| Comp Ex. 1 | Boehmite 600 nm | Acryl binder | 4 | 4.7 | 95 | 5.6/5.0 | B |
| Comp Ex. 2 | Boehmite 600 nm | PAM1 | 4 | 5.0 | 90 | 0.5/0.5 | B |
| Comp Ex. 3 | Boehmite 600 nm | PEI | 4 | 4.3 | 80 | 19.0/17.5 | C |
| Comp Ex. 4 | Boehmite 600 nm | PAM2 | 4 | 4.8 | 89 | 1.0/0.5 | B |

(Ex.: Example; Comp Ex.: Comparative example)
(Coating(loading) amount: Weight of coating layer per unit area of separator)

As shown in Table 1, it was confirmed that Examples 1 to 11 according to an example embodiment of the disclosed technology had higher Gurley permeability, lower heat shrinkage rates, and no adhesion in the strawboard adhesive strength test as is Comparative Examples 1 to 4.

In addition, the lithium secondary battery was manufactured as described above using the manufactured separator and the physical properties were measured.

### [Initial Resistance Characteristics of Lithium Secondary Battery]

Each battery manufactured by the assembly process according to the examples and the comparative Examples was charged at a constant current-constant voltage (CC-CV) of 4.2 V using a charge/discharge cycle instrument, and then discharged. Then, direct current internal resistance (DC-IR) was measured at 60% of state of charge (SOC) by a J-pulse method.

### [Storage Stability at 60° C.]

Each battery (2 Ah Cell) manufactured by an assembly process according to the Examples and the Comparative Examples was stored in an oven at 60° C. for 24 days, direct current internal resistance (DC-IR) was measured by the J-pulse method described above, and then a resistance increase rate was calculated. The resistance increase rate ΔR was calculated from the following equation. The resistance of each example and comparative example was relatively evaluated based on Comparative Example 1, and the higher the numerical value, the lower the relative resistance increase rate.

$$△ R ( \% ) = ( R 2 - R 1 ) / R 1 \times 100$$

Here, R1 is an initial resistance before experiment of each manufactured battery, and R2 is a resistance after storing the battery at 60° C. for 28 days.

The capacity retention rate ΔC was calculated from the following equation. The capacity of each example and comparative example was relatively evaluated based on Comparative Example 1, and the higher the numerical value, the lower the relative capacity retention rate.

$$△ C ( \% ) = [ ( discharge capacity after stored in oven for 28 days - discharge capacity before stored in oven ) ] / ( discharge capacity before stored in oven ) ] \times 100$$

### [400 Cycle Life]

Each battery manufactured by the assembly process according to the examples and the comparative Examples was charged at a constant current-constant voltage (CC-CV) of 4.2 V using a charge/discharge cycle instrument, and then discharged.

The lithium battery was charged at constant current with a 0.5 C rate at 25° C. until the voltage reached 4.2 V, and charged at constant voltage until the current was 0.01 C while maintaining 4.2 V. Subsequently, a cycle of discharging at a constant current of 0.5 C until the voltage reached 3.0 V during discharging was repeated 400 times. The discharge capacity at the capacity retention rate of 400 cycles was measured and calculated, and as the resistance, direct current internal resistance (DC-IR) was measured by a J-pulse method and a resistance increase rate was calculated. The resistance of each example and comparative example was relatively evaluated based on Comparative Example 1, and the higher the numerical value, the lower the relative resistance increase rate.

$$△ R ( \% ) = ( R 3 - R 1 ) / R 1 \times 100$$

Here, R1 is an initial resistance before an experiment of each manufactured battery, and R3 is a resistance after 400 cycles.

The capacity retention rate ΔC was calculated from the following equation. The capacity of each example and comparative example was relatively evaluated based on Comparative Example 1, and the higher the numerical value, the lower the relative capacity retention rate.

$$△ C ( \% ) = [ \text{} ( discharge capacity after 400 cycles - initial discharge capacity ) / ( initial discharge capacity ) ] / 100$$

### [Analysis of Gas Emission]

Gas emission was measured by preparing a 100% charged SOC battery, measuring volume using a density meter, storing the battery in an oven at 60° C. for 10 weeks, and measuring the volume in the same manner. The volume changed relative to the volume at 0 weeks of storage (Volume increase rate ΔV) was calculated by the following equation. Change in volume in each example and comparative example was relatively evaluated based on Comparative Example 1, and the lower the numerical value, the less the gas emission.

$$Volume increase rate △ V ( \% ) = [ \text{} volume at 10 th week - volume at 0 th week ) / volume at 0 th week ] \times 100$$

As described above, the physical properties of the batteries of the remaining examples and comparative examples were relatively evaluated based on the measured values of Comparative Example 1.

The results are shown in the following Table 2.

TABLE 2

| | | | | | | | | Gas |
|---|---|---|---|---|---|---|---|---|
| | | | | | | High-temperature | | analysis |
| | | | | 400 cycle life | | storage (6 W) | | (8 W) |
| | Initial performance | | | Capacity | Resistance | Capacity | Resistance | Gas |
| | Power | ACIR | DCIR | retention | increase | retention | increase | emission |
| | (W/kg) | (mΩ) | (mΩ) | rate (Ah) | rate (mΩ) | rate (Ah) | rate (mΩ) | (ml) |
| Ex. 1 | Eq. | Eq. | Eq. | Eq. | 6.1% | 5.2% | 7.0% | 7.4% |
| | | | | | lower | higher | lower | lower |
| Ex. 2 | Eq. | 4% | 2% | Eq. | 7.5% | 8.2% | 7.8% | 17.3% |
| | | lower | lower | | lower | higher | lower | lower |
| Ex. 3 | Eq. | 2% | 3% | Eq. | 6.9% | 8.3% | 6.7% | 11.4% |
| | | lower | lower | | lower | higher | lower | lower |
| Ex. 4 | Eq. | 2% | Eq. | Eq. | 7.0% | 6.8% | 6.5% | 7.7% |
| | | lower | | | lower | higher | lower | lower |
| Ex. 5 | Eq. | 2% | 2% | Eq. | 7.6% | 7.1% | 6.9% | 14.8% |
| | | lower | lower | | lower | higher | lower | lower |
| Ex. 6 | Eq. | Eq. | Eq. | Eq. | 3.2% | 4.7% | 4.5% | 5.6% |
| | | | | | lower | higher | lower | lower |
| Ex. 7 | Eq. | 2% | 3% | Eq. | 6.7% | 5.7% | 7.3% | 8.1% |
| | | lower | lower | | lower | higher | lower | lower |
| Ex. 8 | Eq. | 4% | 5% | Eq. | 8.5% | 8.5% | 9.7% | 19.3% |
| | | lower | lower | | lower | higher | lower | lower |
| Ex. 9 | Eq. | 2% | 4% | Eq. | 7.0% | 9.0% | 7.9% | 11.7% |
| | | lower | lower | | lower | higher | lower | lower |
| Ex. 10 | Eq. | 2% | 2% | Eq. | 7.1% | 6.8% | 7.4% | 8.3% |
| | | lower | lower | | lower | higher | lower | lower |
| Ex. 11 | Eq. | 2% | 5% | Eq. | 7.2% | 8.1% | 7.3% | 15.5% |
| | | lower | lower | | lower | higher | lower | lower |
| Comp | St. | St. | St. | St. | St. | St. | St. | St. |
| Ex. 1 | | | | | | | | |
| Comp | Eq. | Eq. | Eq. | Eq. | 3.3% | Eq. | 5.7% | 2% |
| Ex. 2 | | | | | higher | | higher | higher |
| Comp | 5% | 5% | 7% | 4% | 7.0% | 9.5% | 20% | 25% |
| Ex. 3 | lower | higher | higher | lower | higher | lower | higher | higher |
| Comp | Eq. | Eq. | Eq. | Eq. | 4.6% | Eq. | 10% | Eq. |
| Ex. 4 | | | | | higher | | higher | |

(Ex.: Example; Comp Ex.: Comparative Example; Eq.: Equivalent; St.: Standard)

As shown in Table 2, when the separators of Examples 1 to 11 based on an example embodiment of the disclosed technology were applied, the capacity retention rate was higher and a resistance increase was lower during storing the battery at a high temperature, as compared with the case of applying an acryl-based binder as in Comparative Example 1, and thus, it was confirmed that the high-temperature storage stability was excellent. In addition, the capacity retention rate was high and the resistance increase rate was low in the 400 cycle characteristics, and thus, excellent long-term battery characteristics were confirmed. Also, low gas emission was confirmed.

In addition, Examples 1 to 11 showed better physical properties as compared with the case using only one type of binder as in Comparative Examples 2 to 4, and thus, it was confirmed that the high-temperature storage characteristics and long-term life of the battery were improved due to the combined use of a specific binder.

In addition, as shown in Examples 1 to 5, when a ternary acrylamide-based crosslinked copolymer and specific inorganic particles were combined and used, the effect was better than in Example 6.

The separator implemented based on an example embodiment of the disclosed technology may have low thermal shrinkage, excellent permeability, and excellent adhesion.

In addition, a lithium secondary battery using the separator implemented based on an example embodiment of the disclosed technology exhibits a high capacity retention rate and a low resistance increase during storage at a high temperature, thereby providing an excellent high temperature storage stability effect.

In addition, the lithium secondary battery using the separator implemented based on an example embodiment of the disclosed technology has a high capacity retention rate and a low resistance increase rate in 400 cycle characteristics, thereby providing excellent long-term storage stability and long-term battery capacity effects.

In addition, the lithium secondary battery using the separator implemented based on an example embodiment of the disclosed technology may have the benefit of significantly decreasing gas emission.

The disclosed technology can be implemented for manufacturing rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to manufacture improved electrochemical devices such as a battery used in various power sources and power supplies, thereby mitigating climate changes in connection with uses of power sources and power supplies. The secondary batteries made by using the disclosed technology can be used to address various adverse effects such as air pollution and greenhouse emissions by powering electric vehicles (EVs) as alternatives to vehicles using fossil fuel-based engines and by providing battery-based energy storage systems (ESSs). Such secondary batteries may include, for example, lithium ion batteries, nickel-cadmium batteries, nickel-metal hydride batteries, and nickel-hydrogen batteries.

Only specific examples of implementations of certain embodiments are described. Variations, improvements and enhancements of the disclosed embodiments and other embodiments may be made based on the disclosure of this patent document.

1. A separator comprising:
a porous substrate; and
a coating layer disposed on one or both surfaces of the porous substrate,
wherein the coating layer comprises a water-soluble composite binder, and inorganic particles, wherein the water-soluble composite binder comprises polyethyleneimine and a nitrogen-containing water-soluble polymer.

2. The separator of claim 1, wherein the nitrogen-containing water-soluble polymer comprises one or more selected from the group consisting of polyvinylpyrrolidone, polyvinylpyrrolidone-based copolymers, and polyacrylamide-based resins.

3. The separator of claim 2, wherein the polyvinylpyrrolidone-based copolymer comprises a unit derived from N-vinyl-2-pyrrolidone and a unit derived from a comonomer, and
the comonomer is any one or a mixture of two or more selected from the group consisting of aromatic vinyl-based monomers; vinyl cyanide-based monomers; aromatic (meth)acrylate having an aryl group, an alkylaryl group, or an arylalkyl group having 6 to 20 carbon atoms; hydroxyl group-containing (meth)acrylate; epoxy group-containing (meth)acrylate; unsaturated carboxylic acid; and vinyl acetate.

4. The separator of claim 2, wherein the polyacrylamide-based resin is a polyacrylamide-based copolymer comprising a unit derived from a (meth)acrylamide-based monomer and a unit derived from a comonomer.

5. The separator of claim 4, wherein the polyacrylamide-based resin comprises: (a) a structural unit derived from a (meth)acrylamide-based monomer, (b) a structural unit derived from a hydroxyl group-containing (meth)acryl-based monomer, and (c) a structural unit derived from a polyfunctional (meth)acrylamide-based monomer.

6. The separator of claim 4, wherein the polyacrylamide-based resin has a weight average molecular weight of 100,000 to 2,000,000 g/mol.

7. The separator of claim 1, wherein the inorganic particles comprise one or more of boehmite and barium sulfate.

8. The separator of claim 7, wherein the inorganic particles further comprise one or more types of inorganic particles selected from alumina, silica, aluminum hydroxide, magnesium hydroxide, calcium oxide, magnesium oxide, titanium oxide, aluminum nitrides, SrTiO₃, SnO₂, CeO₂, NiO, ZnO, ZrO₂, Y₂O₃, and SiC.

9. The separator of claim 1, wherein the inorganic particles include a mixture of two or more types of inorganic particles having different average particle diameters from each other.

10. The separator of claim 1, wherein the inorganic particles have an average diameter of 200 to 1000 nm.

11. The separator of claim 1, wherein the coating layer has a weight ratio between the inorganic particles and the water-soluble composite binder of 50:50 to 99.9:0.1.

12. The separator of claim 1, wherein the content of the polyethyleneimine is 1 to 50 wt % of the total content of the water-soluble composite binder.

13. The separator of claim 1, wherein the polyethyleneimine and the nitrogen-containing water-soluble polymer are in a weight ratio of 10 to 90:90 to 10.

14. The separator of claim 1, wherein the water-soluble composite binder further comprises one or more resins selected from the group consisting of polyvinyl acetate, acryl-based resins, polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polymethylmethacrylate, polyacrylonitrile, ethylene vinyl acetate copolymer, carboxymethyl cellulose, and polyimide.

15. The separator of claim 1, wherein a thickness of the coating layer is 0.1 to 50% of a total thickness of the separator.

16. The separator of claim 1, wherein the coating layer is formed to be 0.5 to 10 g/m².

17. The separator of claim 1, wherein the porous substrate is any one or a lamination of two or more selected from the group consisting of a porous film, a nonwoven fabric, and a woven fabric.

18. The separator of claim 1, wherein the porous substrate has a thickness of 1 to 80 m.

19. A lithium secondary battery comprising a separator, wherein the separator comprises:
a porous substrate; and
a coating layer disposed on one or both surfaces of the porous substrate,
wherein the coating layer comprises a water-soluble composite binder, and inorganic particles, wherein the water-soluble composite binder comprises polyethyleneimine and a nitrogen-containing water-soluble polymer.

20. The lithium secondary battery of claim 19, wherein the nitrogen-containing water-soluble polymer comprises one or more selected from the group consisting of polyvinylpyrrolidone, polyvinylpyrrolidone-based copolymers, and polyacrylamide-based resins.
